(19) United States
(12) Patent Application Publication
(10) Pub. No.: US 2013/0342052 A1
(43) Pub. Date: Dec. 26, 2013

(54) ELECTRIC MACHINE WITH CIRCUMFERENTIAL ROTOR AND HOUSING FINS

(71) Applicants: Paul F. Turnbull, Canton, MI (US); Steven Lee Hayslett, Troy, MI (US); John C. Morgante, Sterling Heights, MI (US)

(72) Inventors: Paul F. Turnbull, Canton, MI (US); Steven Lee Hayslett, Troy, MI (US); John C. Morgante, Sterling Heights, MI (US)

(73) Assignee: GM GLOBAL TECHNOLOGY OPERATIONS LLC, Detroit, MI (US)

(21) Appl. No.: 13/530,198

(22) Filed: Jun. 22, 2012

(51) Int. Cl. H02K 9/22

(52) U.S. Cl. 310/64

(57) ABSTRACT

An electric machine is provided with a rotor core rotatable about a central axis. A first end ring is operatively connected to one end of the rotor core. A first housing component at least partially encloses the rotor core. At least one first rotor fin extends from the first end ring in a first direction which may be substantially parallel to the central axis. At least one first housing fin extends from the first housing component in a second direction that is substantially opposite to the first direction. The first rotor and housing fins extend circumferentially around the central axis. The first rotor fin and the first housing fin are configured to interleave, thereby enhancing heat transfer between the first rotor and housing fin, and cooling the rotor core.

### TECHNICAL FIELD

The present invention relates generally to an electric machine, and more specifically, to an electric machine having circumferential cooling fins.

### BACKGROUND

An electric machine or motor/generator generally includes a rotor assembly rotatable within a stator which generally includes a plurality of windings and magnetic poles of alternating polarity. In a generator mode, the rotation of the rotor induces an electric current to flow in the coils of the stator. Alternately, if an electric current is passed through the stator coils, the energized coils will cause the rotor to rotate and thus the machine will perform as a motor. As with any energy conversion device, the motor/generators are less than 100 percent efficient, and reject some energy as heat. Efficient removal of this waste heat is desirable. Rotors in a closed motor are challenging to cool since they are rotating and direct cooling is not possible.

### SUMMARY

An electric machine includes a rotor assembly with a rotor core rotatable about a central axis. A first end ring is operatively connected to one end of the rotor core. A first housing component at least partially encloses the rotor core. At least one first rotor fin extends from the first end ring in a first direction which may be substantially parallel to the central axis. At least one first housing fin extends from the first housing component in a second direction that is substantially opposite to the first direction. The first rotor fins and first housing fins extend circumferentially around the central axis.

The first rotor fin and the first housing fin are configured to interleave or interlace, i.e., the first housing fin is positioned in a first gap adjacent to the first rotor fin and vice-versa. This configuration enhances heat transfer between the first rotor fin and the first housing fin. The first rotor fins increase the surface area of the rotor assembly that is in close proximity to the relatively cool first housing component, thereby cooling the rotor assembly. The temperature of the rotor assembly is reduced, which reduces the risk of damaging thermally sensitive components within the machine and improves the efficiency of the machine.

An additional first rotor fin may extend from the first end ring in the first direction and circumferentially around the central axis. An additional first housing fin may extend from the first housing component in the second direction and circumferentially around the central axis. The first rotor fin, additional first rotor fin, first housing fin and additional first housing fin are each respectively positioned at a different radial distance from the central axis.

The electric machine may include a second end ring operatively connected to another end of the rotor core, where a second housing component at least partially encloses the rotor core. At least one second rotor fin may extend from the second end ring in the second direction. At least one second housing fin may extend from the second housing component in the first direction. The second rotor fin and the second housing fin extend circumferentially around the central axis. The second rotor fin and second housing fin are configured to interleave, thereby enhancing heat transfer between the second rotor fin and the second housing fin.

The second rotor fins increase the surface area of the rotor assembly that is in close proximity to the relatively cool second housing component, thereby cooling the rotor assembly. Accordingly, cooling of the rotor assembly is provided without opening the electric machine to environmental effects or introducing additional cooling fluids into the interior of the machine.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic cross-sectional view of an electric machine having a rotor assembly enclosed by first and second housing component and including one or more first rotor fins;

FIG. 2 is a schematic perspective view of the rotor assembly shown in FIG. 1;

FIG. 3 is a schematic partially perspective, partially cross-sectional view through axis 3-3 in FIG. 1, showing the first housing component and a portion of the rotor assembly;

FIG. 4 is a schematic perspective view of only the second housing component shown in FIG. 1;

FIG. 5 is a schematic partially cross-sectional close-up view of the first rotor fins shown in FIG. 1; and

FIG. 6 is a schematic enlarged view of portion 6 of FIG. 1.

### DETAILED DESCRIPTION

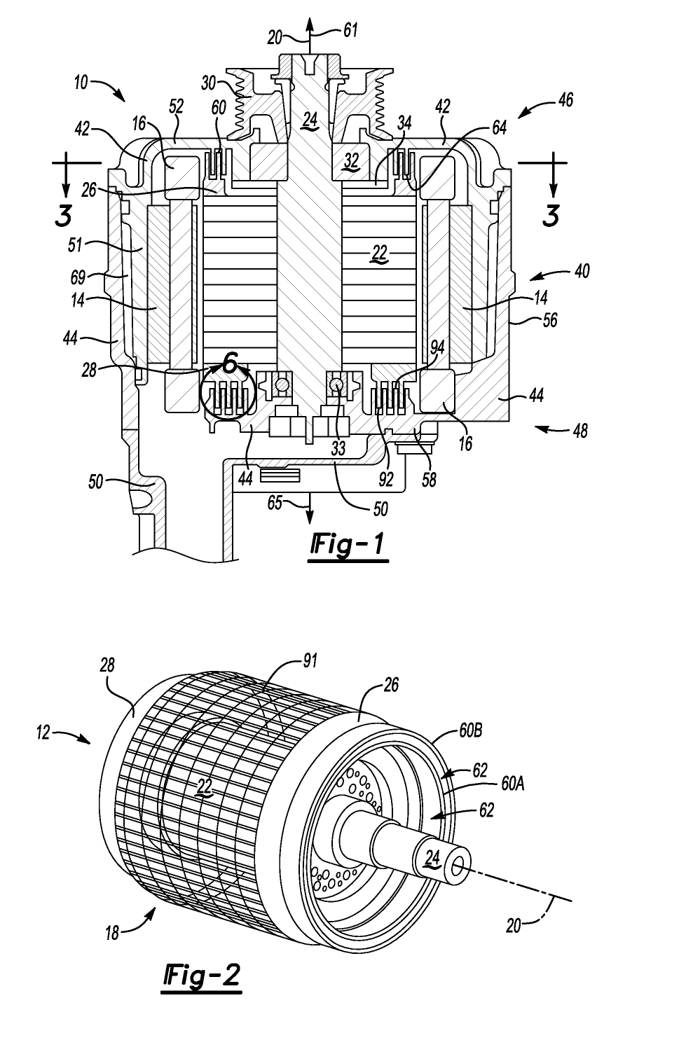

Referring to the Figures, wherein like reference numbers refer to the same or similar components throughout the several views, FIG. 1 shows a schematic cross-sectional view of an electric machine 10 having a rotor assembly 12. Referring to FIG. 1, the rotor assembly 12 is rotatable within a generally annular stator 14 having a plurality of windings 16. Those having ordinary skill in the art will recognize that terms such as “above,” “below,” “upward,” “downward,” et cetera, are used descriptively of the figures, and do not represent limitations on the scope of the invention, as defined by the appended claims.

FIG. 2 is a schematic perspective view of the rotor assembly 12. Referring to FIG. 2, the rotor assembly 12 includes a rotor core 18. Referring to FIGS. 1-2, the rotor assembly 12 is rotatable about a center axis 20. The center axis 20 may be used to define an axial direction that is substantially parallel to the axis 20. A corresponding radial direction moves outward from the center axis 20. Referring to FIGS. 1-2, a first end ring 26 is operatively connected to one end of the rotor core 18. Referring to FIGS. 1-2, a second end ring 28 may be operatively connected to another end of the rotor core 18. Referring to FIG. 2, the rotor core 18 may be formed by stacking one or more laminations 22 around a shaft 24. The laminations 22 are typically annularly-shaped disks.

Referring to FIG. 1, a belt-driven pulley 30 may be fastened to one end of the shaft 24 (shown in FIGS. 1-2) to provide a rotating drive to the shaft 24. The shaft 24 may be rotatably supported by bearing elements 32, 33. Referring to FIG. 1, a bearing retainer plate 34 and mechanical fasteners (such as screws) may be employed for structural support.

Referring to FIG. 1, the internal components of the machine 10 are enclosed by a housing 40. The housing 40 includes a first housing component 42 located at a first end 46 of the machine 10. Referring to FIG. 1, a second housing component 44 is disposed at a second end 48 of the machine 10. Referring to FIG. 1, an additional connector cover 50 may be attached to the second housing component 44. By way of a non-limiting example, the first end 46 and second end 48 may be front and rear portions, respectively, of the machine 10.

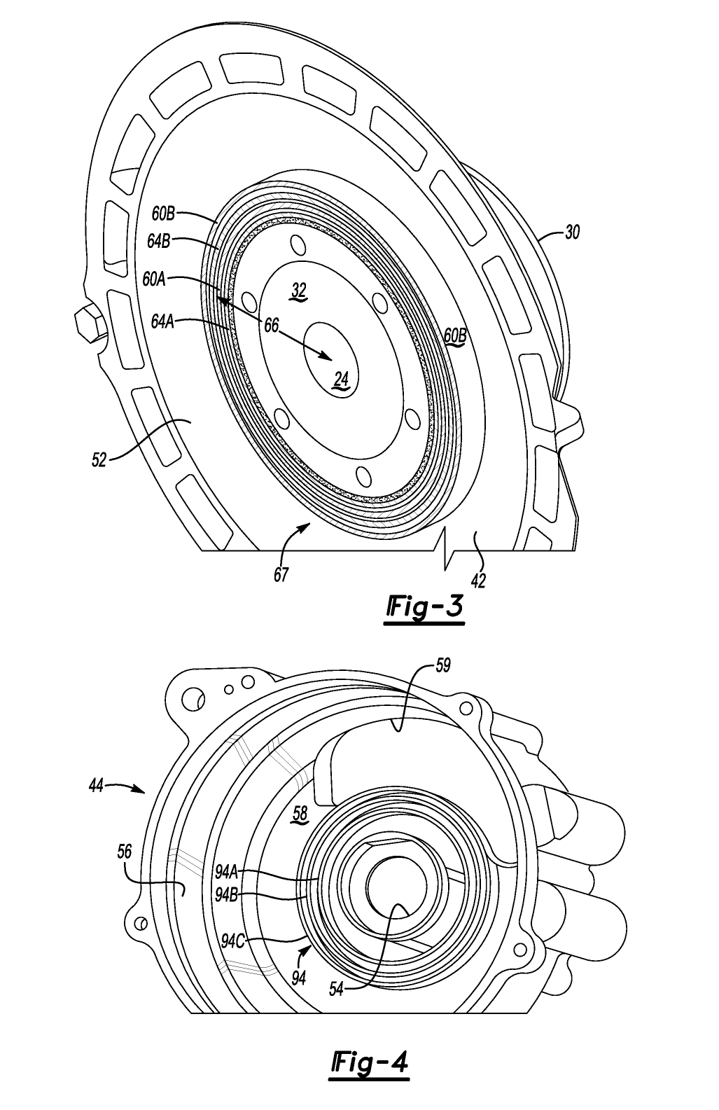

FIG. 3 is a schematic partially cross-sectional view, partially perspective view of the first housing component 42, cut through axis 3-3 in FIG. 1. For clarity, the stator windings 16 are not shown. Referring to FIG. 1, the first housing component 42 includes a hollow cylindrical portion 51 and a base portion 52 (shown in FIG. 3) that extends in a generally radial direction from the central axis 20. FIG. 3 shows portions of the shaft 24, bearing element 32 and pulley 30 (also shown in FIG. 1).

FIG. 4 is a schematic perspective view of only the second housing component 44. For clarity, the shaft 24 and other components of the rotor assembly 12 are not shown. Referring to FIG. 4, an aperture 54 is shown where the shaft 24 (shown in FIGS. 1-2) would be positioned. Referring to FIGS. 1 and 4, the second housing component 44 includes a hollow cylindrical portion 56 and a base portion 58 that extends in a generally radial direction from the central axis 20. Referring to FIG. 4, the second housing component 44 may include another aperture or cutout 59 for electrical connections or wires (not shown).

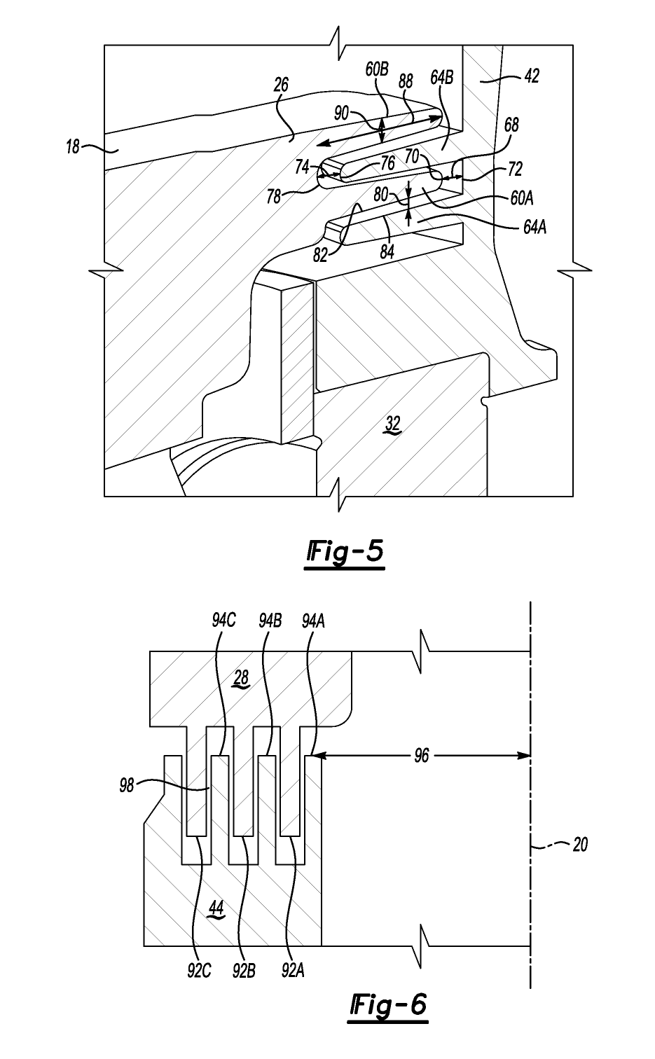

Referring to FIGS. 1-3, the rotor assembly 12 includes one or more projections or extensions, referred to herein as first rotor fins 60, extending from the first end ring 26 in a first direction 61 (see FIG. 1) that may be substantially parallel to the central axis 20. In the illustrated embodiment, two first rotor fins 60A and 60B are shown, however, any number may be employed depending on the particular application. FIG. 5 is a schematic partially cross-sectional, close-up view showing the first rotor fins 60A, B. Referring to FIG. 2, each of the first rotor fins 60A, B defines a respective first gap 62 adjacent to each of the first rotor fins 60A, B. Referring to FIG. 2, each of the first rotor fins 60A, B extends circumferentially around the central axis 20 (or shaft 24). As is described below, the second end ring 28 may also include similar extensions or fins.

Referring to FIGS. 1, 3 and 5, one or more first housing fins 64 extend from the first housing component 42, in a second direction 65 (see FIG. 1) that is substantially opposite to the first direction 61. While the illustrated embodiment shows two first housing fins 64A, B, any number may be employed. Referring to FIG. 3, each of the first housing fins 64A, B extends circumferentially around the central axis 20. Referring to FIGS. 1 and 3, the first housing fins 64A, B may extend from the base portion 52 of the first housing component 42. The first rotor fins 60 rotate with the rest of the rotor assembly 12 while the first housing fins 64 remain stationary.

Referring to FIG. 3, the first rotor fins 62A, B and first housing fins 64A, B are each positioned respectively at a different radial distance 66 from the central axis 20. Referring to FIG. 3, the first rotor fins 60 and first housing fins 64 are configured to interleave or interlace, i.e., the first housing fins 64 are positioned in the respective first gaps 62 between the first rotor fins 60 and vice-versa (the first rotor fins 60 are positioned in the respective spaces between the first housing fins 64). Stated differently, the first rotor fins 60 and first housing fins 64 overlap axially without touching. Referring to FIG. 3, the interleaving of the first rotor fins 60 and the first housing fins 64 defines a plurality of concentric circles 67 in the cut-away view.

The first rotor fins 60A, B are extensions of the first end ring 26, which is part of the rotor assembly 12. As is known to those skilled in the art, the rotor assembly 12 generates heat. The first rotor fins 60A, B and the first housing fins 64A, B are configured to interleave, thereby enhancing heat transfer between the first rotor fins 60A, B and the first housing fins 64A, B and allowing cooling of the rotor assembly 12. The first housing fins 64A, B are extensions of the relatively cool housing 40 (which includes first and second housing components 42, 44) which functions as a heat sink. Referring to FIG. 1, the housing 40 (and stator 14) may be cooled by an annular cooling chamber 69 defined by open areas between portions of the housing 40. In one embodiment, the rotor assembly 12 is approximately at a temperature of 200 Celsius, the stator 14 is at approximately 100 Celsius and the housing 40 is at approximately 40 Celsius (all shown in FIG. 1).

FIG. 5 is a schematic partially cross-sectional, close-up view of the first rotor fins 60 and the first housing fins 64. Referring to FIG. 5, a first axial clearance 68 is defined between a crest 70 of the first rotor fin 60 and a corresponding valley 72 of the interleaving first housing fin 64. A second axial clearance 74 is defined between a crest 76 of the first housing fin 64 and a corresponding valley 78 of the interleaving first rotor fin 60. A radial clearance 80 is defined between respective edges 82, 84 of the first rotor fin 60 and the adjacent first housing fin 64. The radial and first and second axial clearances 80, 68, 74 are configured to be sufficiently small to maximize heat transfer or cooling between the first rotor fin 60 and the first housing fin 64. By way of a non-limiting example, the radial clearance 80 may be less than 0.5 mm. By way of a non-limiting example, the first and second axial clearances 68, 74 may be approximately between 1 and 2 mm. In one embodiment, the first and second axial clearances 68, 74 are the same. In another embodiment, the first and second axial clearances 68, 74 are different.

Referring to FIG. 5, heat from the rotor assembly 12 (through the first rotor fins 60) is transferred to the space immediately surrounding the first rotor fins 60, i.e., the radial and first and second axial clearances 80, 68, 74, and then to the relatively cool first housing fin 64A, B. The first rotor fins 60A, B increase the surface area of the rotor assembly 12 that is in close proximity to the relatively cool housing 40, thereby increasing heat transfer. The temperature of the rotor assembly 12 is reduced, which reduces the risk of damaging thermally sensitive components within the machine 10 and improves the efficiency of the machine 10.

The configuration of interleaved circumferential first rotor fins 60 and first housing fins 64 encourages Taylor-Couette flow between the rotating rotor assembly 12 and the stationary housing 40, thereby further enhancing heat transfer therebetween. Taylor-Couette flow refers to the fluid flow occuring in an annular region between differentially rotating concentric cylinders. Taylor-Couette flow most often occurs when an inner cylinder (such as the rotor assembly 12) is rotating and an outer cylinder (such as the housing 40) is fixed. When the angular velocity of the rotor assembly 12 is increased above a certain threshold, Taylor-Couette flow becomes unstable and a secondary steady state characterized by toroidal vortices emerges. Due to the vortices, high-speed fluid near the rotating rotor assembly 12 is carried outward in the outflow regions between vortices, while low-speed fluid near the fixed housing 40 is carried inward in the inflow regions between vortices, enhancing heat transfer.

The configuration of interleaved circumferential first rotor fins 60 and first housing fins 64 also encourages radiative and conductive heat transfer. The high thermal gradient between the relatively hot first rotor fins 60 and the relatively cool first housing fins 64 results in enhanced heat flow and cooling between the rotor assembly 12 and housing 40.

Referring to FIG. 5, the first rotor fins 60 define a length 88 in the first direction 61 that is substantially parallel to the central axis 20. The first rotor fins 60 define a width 90 in a direction substantially perpendicular to the central axis 20. Each of the first rotor fins 60 may incorporate different lengths and widths. Similarly, each of the first housing fins 64 defines a length and a width which may be different from the first rotor fins 60. In one embodiment, the lengths of the first rotor fins 60A, B are 3.5, 4 mm, respectively while the lengths of the first housing fins 64A, B are 3.3, 4.2 mm, respectively. In one embodiment, the widths of the first rotor fins 60A, B are 1.7, 2 mm, respectively while the widths of the first housing fins 64A, B are 1.3, 2.5 mm, respectively.

In one embodiment, the first rotor fins 60 and the first end ring 26 define a unitary one-piece configuration. The first rotor fins 60 may be integrally formed with the first end ring 26. By way of a non-limiting example and referring to FIG. 2, the first and second end rings 26, 28 may be formed in a casting process by pouring molten metal down slots at the outer edges of the laminations 22 that solidify into bars 91 and the first and second end rings 26, 28 at both ends of the rotor assembly 12. In one embodiment, the first rotor fins 60 may be formed in the same casting process with the first end ring 26 by modifying the forming dies or casting molds (not shown) for the first end ring 26. In another embodiment, the first rotor fins 60 may be formed separately and attached to the first end ring 26. The first and second end rings 26, 28 may be made from a thermally conductive material. By way of non-limiting examples, the thermally conductive material may be aluminum, copper, bronze or brass. The first rotor fins 60 may also be composed of a thermally conductive material. Similarly, the first housing fins 64 and the first housing component 42 may define a unitary one-piece configuration.

A particular embodiment may include interleaved circumferential first rotor fins 60 and first housing fins 64 as described above at multiple locations within the machine 10 or at just one location. Referring to FIG. 1, the second end ring 28 may include one or more second rotor fins 92 and the second housing component 44 may include one or more second housing fins 94. Referring to FIG. 1, the second rotor fins 92 extend from the second end ring 28 in a direction substantially parallel to the central axis 20, shown here as the second direction 65. Referring to FIG. 1, the second housing fins 94 extend from the second housing component 44 in the first direction 61 (so that they are substantially opposite to the second rotor fins 94). Referring to FIG. 4, the second housing fins 94 may extend from the base portion 58 of the second housing component 44.

FIG. 6 is a schematic enlarged view of portion 6 of FIG. 1, showing second rotor fins 92A,B and C and second housing fins 94A,B and C. While three second rotor fins 92A-C and three second housing fins 94A-C are shown in FIG. 6, it is to be understood that any number may be employed for each application. The second rotor fin 92 may be similar in all respects to the first rotor fin 60. The second housing fin 94 may be similar in all respects to the first housing fin 64.

Referring to FIG. 6, the second rotor fins 92A-C and the second housing fins 94A-C extend circumferentially around the central axis 20 respectively at varying radial distances 96 (shown for fin 92A) from the central axis 20. Referring to FIG. 6, the second rotor fins 92A-C and second housing fins 94A-C are configured to interleave, such that the second housing fins 94A-C are positioned in respective second gaps 98 adjacent to the second rotor fins 92A-C, thereby enhancing heat transfer between the second rotor fins 92 and second housing fins 94, as discussed above with respect to the first rotor and housing fins 60, 64.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

1. An electric machine comprising:
a rotor core rotatable about a central axis and having an end;
an end ring operatively connected to the end of the rotor core;
a housing component at least partially enclosing the rotor core;
at least one rotor fin extending from the end ring in a first direction;
at least one housing fin extending outwardly from the housing component in a second direction substantially opposite to the first direction;
wherein the at least one rotor fin and the at least one housing fin extend circumferentially around the central axis; and
wherein the at least one rotor fin and the at least one housing fin are configured to interleave, thereby enhancing heat transfer between the at least one rotor fin and the at least one housing fin.

2. The machine of claim 1, wherein the first direction is substantially parallel to the central axis.

3. The machine of claim 1, wherein the rotor fin and the end ring define a unitary one-piece configuration.

4. The machine of claim 1, further comprising:
an axial clearance defined between a crest of the rotor fin and a corresponding valley of the housing fin; and
a radial clearance defined between respective edges of the rotor fin and the housing fin.

5. The machine of claim 4, wherein the axial clearance is approximately between 1 and 2 mm.

6. The machine of claim 4, wherein the radial clearance is approximately 0.5 mm.

7. The machine of claim 1, wherein the rotor fin defines a length substantially parallel to the central axis and a width substantially perpendicular to the central axis.

8. The machine of claim 7, wherein the length of the rotor fin is approximately between 3 and 4 mm.

9. The machine of claim 7, wherein the width of the rotor fin is approximately between 1 and 2 mm.

10. The machine of claim 1, further comprising:
an additional rotor fin extending from the end ring in the first direction and circumferentially around the central axis;
an additional housing fin extending from the housing component in the second direction and circumferentially around the central axis; and
wherein the rotor fin, additional rotor fin, housing fin and additional housing fin are each positioned at a different radial distance respectively from the central axis.

11. The machine of claim 1, wherein:
the housing component includes a hollow cylindrical portion and a base portion that extends in a generally radial direction from the central axis; and
the housing fin extends from the base portion of the housing component.

12. An electric machine comprising:
a rotor core rotatable about a central axis;
a first end ring operatively connected to one end of the rotor core;
at least one first rotor fin extending from the first end ring in a first direction substantially parallel to the central axis;
a first housing component at least partially enclosing the rotor core;
at least one first housing fin extending from the first housing component in a second direction substantially opposite to the first direction;
wherein the first rotor fin and the first housing fin extend circumferentially around the central axis; and
wherein the first rotor fin and first housing fin are configured to interleave, thereby enhancing heat transfer between the first rotor fin and the first housing fin.

13. The machine of claim 12, further comprising:
an additional first rotor fin extending from the first end ring in the first direction and circumferentially around the central axis;
an additional first housing fin extending from the first housing component in the second direction and circumferentially around the central axis; and
wherein the first rotor fin, additional first rotor fin, first housing fin and additional first housing fin are each positioned at a different radial distance from the central axis.

14. The machine of claim 12, further comprising:
a second end ring operatively connected to another end of the rotor core;
a second rotor fin extending from the second end ring in the second direction;
a second housing component at least partially enclosing the rotor core;
a second housing fin extending from the second housing component in the first direction;
wherein the second rotor fin and the second housing fin extend circumferentially around the central axis; and
wherein the second rotor fin and second housing fin are configured to interleave, thereby enhancing heat transfer between the second rotor fin and the second housing fin.

15. The machine of claim 14, wherein:
the second housing component includes a hollow cylindrical portion and a base portion that extends in a generally radial direction from the central axis; and
the second housing fin extends from the base portion of the second housing component.

16. The machine of claim 14, further comprising:
an additional second rotor fin extending from the second end ring in the second direction and circumferentially around the central axis;
a second housing fin extending from the second housing component in the first direction and circumferentially around the central axis; and
wherein the second rotor fin, additional second rotor fin, second housing fin and additional second housing fin are each respectively positioned at a different radial distance from the central axis.

17. An electric machine comprising:
a rotor core rotatable about a central axis;
a first end ring operatively connected to one end of the rotor core;
at least two first rotor fins extending from the first end ring in a first direction substantially parallel to the central axis;
a first housing component at least partially enclosing the rotor core;
at least two first housing fins extending from the first housing component in a second direction substantially opposite to the first direction;
wherein the at least two first rotor fins and the at least two first housing fins are each positioned at a different respective radial distance from the central axis and extend circumferentially around the central axis;
a second end ring operatively connected to another end of the rotor core;
a second rotor fin extending from the second end ring in the second direction;
a second housing component at least partially enclosing the rotor core;
a second housing fin extending from the second housing component in the first direction;
wherein the second rotor fin and the second housing fin extend circumferentially around the central axis; and
wherein the second rotor fin and second housing fin are configured to interleave, thereby enhancing heat transfer between the second rotor fin and the second housing fin.
